(19) United States
(12) Patent Application Publication
(10) Pub. No.: US 2024/0154148 A1
(43) Pub. Date: May 9, 2024

(54) METHOD FOR PRODUCING POWER STORAGE MODULE, GRIPPING JIG, AND POSITION CORRECTING JIG

(71) Applicant: TOYOTA JIDOSHA KABUSHIKI KAISHA, Toyota-shi (JP)

(72) Inventor: Kouta MARUYAMA, Aichi-ken (JP)

(73) Assignee: TOYOTA JIDOSHA KABUSHIKI KAISHA, Toyota-shi (JP)

(21) Appl. No.: 18/486,422

(22) Filed: Oct. 13, 2023

(30) Foreign Application Priority Data
Nov. 4, 2022 (JP) 2022-177239

(51) Int. Cl. H01M 10/04; H01M 50/26; H01M 50/264

(52) U.S. Cl. CPC H01M 10/0418; H01M 50/26; H01M 50/264

(57) ABSTRACT

A main object of the present disclosure is to provide a method for producing a power storage module capable of inhibiting interference of a nest and a frame body during arranging the frame body in a side surface of a layered member. The present disclosure achieves the object by providing a method for producing a power storage module, the method including a preparing step of preparing a layered member, and a frame body arranging step of arranging a frame body in a side surface of the layered member, wherein a frame body bonding jig and a position correcting jig are used in the frame body arranging step.

### TECHNICAL FIELD

Present disclosure relates to a method for producing a power storage module, a gripping jig, and a position correcting jig.

### BACKGROUND ART

In a method for producing a power storage module of such as a secondary battery, a technique of forming a seal member to surround an electrode layered body has been known. For example, Patent Literature 1 discloses a production device of a power storage module comprising an electrode layered body including a plurality of electrode layered in a first direction, and a seal member surrounding the electrode layered body when viewed from the first direction. Also, Patent Literature 1 discloses a method for forming a resin part by installing a nest including a continuous hole forming part that forms a continuous hole, to a mold, and then performing injection molding. Also, for example, in FIG. 8 of Patent Literature 1, it is disclosed that the second resin seal 24 configuring the resin part has a frame shape divided to surround each individual continuous hole 24a.

### CITATION LIST

### Patent Literature

Patent Literature 1: Japanese Patent Application Laid-Open (JP-A) No. 2020-145032

### SUMMARY OF DISCLOSURE

### Technical Problem

As disclosed in Patent Literature 1, when a continuous hole and a resin part (in a frame shape in particular) are formed by using a nest mold and injection molding, problem is that the difficulty of arranging the facility and the mold is high. In specific, it is necessary to assemble an insert-type nest mold while absorbing unevenness of the thickness of a layered member, and the layered member and the mold need to be arranged with high accuracy in order to prevent the resin from leaking; thus, the difficulty of arranging the facility and the mold is high.

To such a problem, the inventor of the present disclosure studied a method for preparing a frame body with a frame shape as an additional member instead of forming the resin part with the frame shape by a resin molding such as injection molding, and then arranging the frame body in a side surface of the layered member. In the method for arranging the frame body in the side surface of the layered body, use of the mold is unnecessary, and thus improvement of productivity can be achieved.

Meanwhile, when the method for arranging the frame body in the side surface of the layered body is adopted, if the extending direction of the next that extends to outside the layered member is not uniform (when the height position of the outside edge part of the nest is not uniform), there is a new problem that the nest and the frame body interfere on the occasion of arranging the frame body in the side surface of the layered member. The present disclosure has been made in view of the above circumstances, and the main object thereof is to provide a method for producing a power storage module capable of inhibiting interference of a nest and a frame body during arranging the frame body in a side surface of a layered member.

### Solution to Problem

[1]

A method for producing a power storage module, the method comprising:
a preparing step of preparing a layered member; and a frame body arranging step of arranging a frame body in a side surface of the layered member, wherein
the layered member includes an electrode layered body including a plurality of electrode layered in a first direction, a seal member surrounding the electrode layered body when viewed from the first direction, and a nest that extends from a side surface of the seal member to outside the seal member;
the frame body arranging step is a step of arranging the frame body in a side surface of the layered member by bonding the seal member and the frame body in a state the nest is inserted in a first penetration region in the frame body;
the frame body arranging step includes:
a jig preparing step of preparing a frame body bonding jig including the frame body, and a gripping jig that grips the frame body and that includes a second penetration region corresponding to the first penetration region, as well as preparing a position correcting jig including a pair of supporting parts and a rodlike part connected to the pair of supporting parts;
a facing arranging step of arranging an outside edge part of the nest in the layered member and the frame body in the frame body bonding jig to face to each other interposing a space;
a position adjusting step of adjusting height position of the outside edge part of the nest by inserting the supporting parts and the rodlike part in the position correcting jig from the second penetration region side toward the first penetration region side in the frame body bonding jig, and putting the nest between the pair of supporting parts from the first direction so as to be fixed; and
a bonding step of bonding the seal member and the frame body by moving the frame body bonding jig to the layered member side while fixing the nest by the pair of supporting parts.

[2]

The method for producing a power storage module according to [1], wherein
the layered member includes a block member arranged in a position overlapping the seal member and the nest when viewed from the first direction; and
in the bonding step, the seal member, the block member, and the frame body are bonded.

[3]

The method for producing a power storage module according to [1] or [2], wherein
the electrode layered body is provided with a bipolar electrode including a cathode layer arranged in one surface of a current collector, and an anode layer arranged in the other surface of the current collector;
the electrode layered body is provided with a plurality of the bipolar electrode in the first direction; and
in the plurality of the bipolar electrode, a separator is respectively arranged between neighboring the bipolar electrode.

[4]

A gripping jig to be used in the method for producing a power storage module according to any one of [1] to [3], the jig including the second penetration region.

[5]

A position correcting jig to be used in the method for producing a power storage module according to any one of [1] to [3], the jig including the pair of supporting parts and the rodlike part.

### Advantageous Effects of Disclosure

The method for producing a power storage module in the present disclosure is capable of inhibiting interference of a nest and a frame body during arranging the frame body in a side surface of a layered member.

### BRIEF DESCRIPTION OF DRAWINGS

FIGS. 1A to 1C are schematic diagrams exemplifying the layered member and the frame body in the present disclosure.

FIGS. 2A to 2D are schematic diagrams exemplifying the frame body bonding jig and the position correcting jig in the present disclosure.

FIGS. 3A to 3D are schematic side views exemplifying the frame body arranging step in the present disclosure.

FIGS. 4A and 4B are schematic diagrams exemplifying the gripping jig in the present disclosure.

FIG. 5 is a schematic cross-sectional view exemplifying the method for forming the layered member in the present disclosure.

FIGS. 6A to 6H are schematic diagrams exemplifying the position correcting jig in the present disclosure.

FIGS. 7A to 7C are schematic diagrams exemplifying the position correcting jig in the present disclosure.

### DESCRIPTION OF EMBODIMENTS

The embodiments in the present disclosure will be hereinafter explained in details with reference to drawings. Each drawing described as below is a schematic view, and the size and the shape of each portion are appropriately exaggerated in order to be understood easily. Furthermore, in the present description, upon expressing an embodiment of arranging one member with respect to the other member, when it is expressed simply “on” or “below”, both of when the other member is directly arranged on or below the one member so as to contact with each other, and when the other member is arranged above or below the one member interposing an additional member, can be included unless otherwise described.

A. Method for Producing Power Storage Module

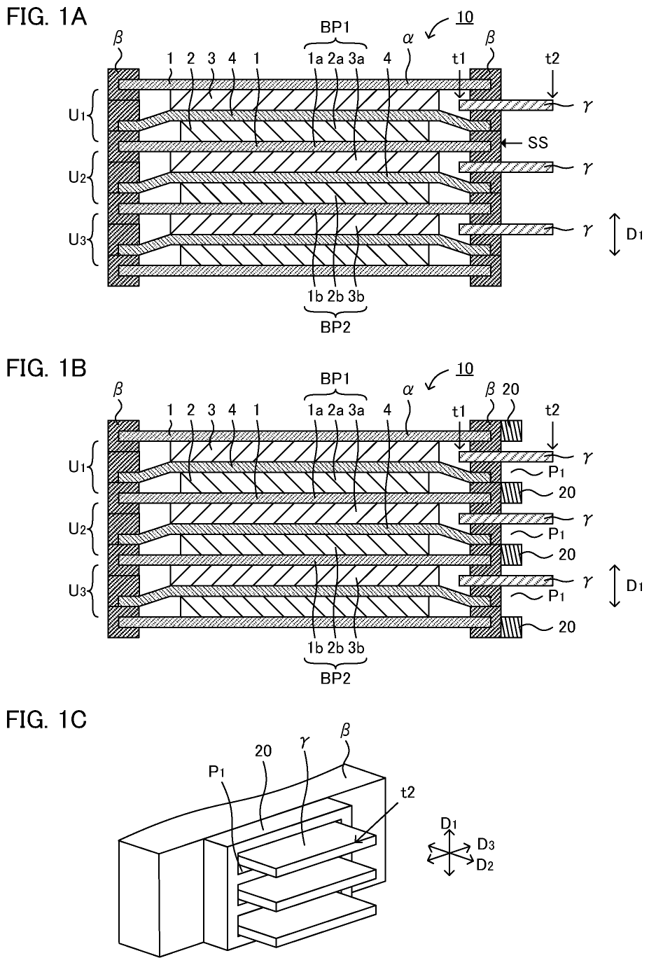

FIG. 1A is a schematic cross-sectional view exemplifying the layered member (layered member before arranging the frame body) in the present disclosure, FIG. 1B is a schematic cross-sectional view exemplifying the layered member (layered member after arranging the frame body) in the present disclosure, and FIG. 1C is a schematic perspective view exemplifying the frame body in the present disclosure.

As shown in FIG. 1A, in the present disclosure, first, layered member 10 is prepared (preparing step). The layered member 10 includes electrode layered body α including a plurality of electrodes (BP1, BP2) layered in a first direction D₁, seal member β surrounding the electrode layered body α when viewed from the first direction D₁, and nest γ that extends from a side surface SS of the seal member β to outside the seal member β. Next, as shown in FIG. 1B, frame body 20 is arranged in the side surface SS of the layered member 10 (side surface SS of the seal member β) (frame body arranging step). As shown in FIGS. 1B and 1C, in the frame body arranging step, the frame body 20 is arranged in the side surface SS of the layered member 10 (side surface SS of the seal member β) by bonding the seal member β and the frame body 20 in a state the nest γ is inserted in a first penetration region P₁ in the frame body 20.

The frame body arranging step in the present disclosure includes, in specific, a jig preparing step, a facing arranging step, a position adjusting step, and bonding step.

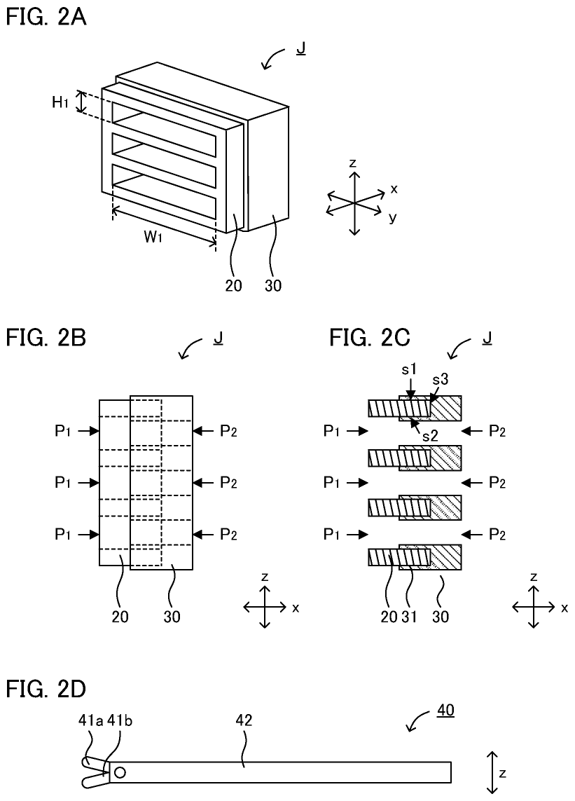

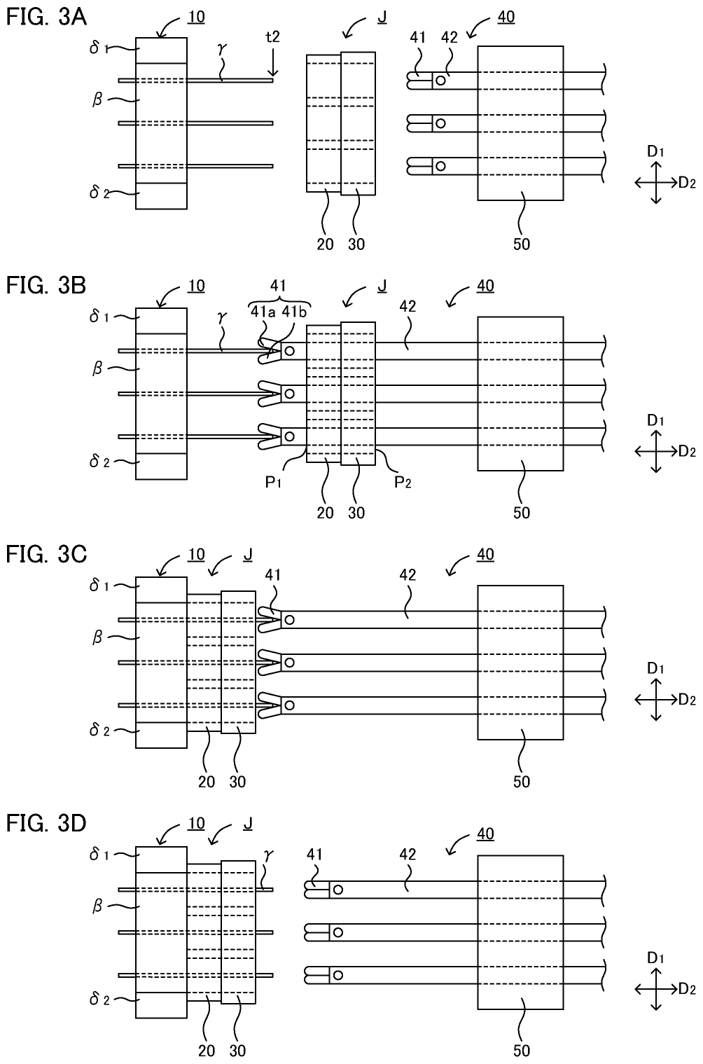

In the jig preparing step, a frame body bonding jig and a position correcting jig are prepared. Here, FIG. 2A is a schematic perspective view exemplifying the frame body bonding jig in the present disclosure, FIG. 2B is a schematic side view when the frame body bonding jig shown in FIG. 2A is viewed from x-z plane, FIG. 2C is a schematic cross-sectional view of cutting the frame body bonding jig shown in FIG. 2A in the x-z plane, and FIG. 2D is a schematic side view exemplifying the position correcting jig in the present disclosure. Also, FIGS. 3A to 3D are schematic side views exemplifying the frame body arranging step in the present disclosure.

As shown in FIGS. 2A to 2C, frame body bonding jig J includes frame body 20, and gripping jig 30 that grips the frame body 20. Also, the frame body 20 includes first penetration region P₁, and the gripping jig 30 includes second penetration region P₂. The first penetration region P₁ and the second penetration region P₂ are communicated in depth direction x. Meanwhile, as shown in FIG. 2D, the position correcting jig 40 includes a pair of supporting parts 41 (41a, 41b) and rodlike part 42 connected to the pair of supporting parts 41.

Next, as shown in FIG. 3A, outside edge part t2 of the nest γ in the layered member 10 and the frame body 20 in the frame body bonding jig J are arranged to face to each other interposing a space (facing arranging step). Next, as shown in FIG. 3B, the supporting parts 41 and the rodlike part 42 in the position correcting jig 40 are inserted from the second penetration region P₂ side toward the first penetration region P₁ side in the frame body bonding jig J, along with second direction D₂ orthogonal to the first direction D₁. Further, the nest γ is put between the pair of supporting parts 41 (41a, 41b) from the first direction D₁ (up and down direction) so as to be fixed. Thereby, the height position of the outside edge part (edge part in the right side of drawing) of the nest γ is adjusted (position adjusting step).

Next, as shown in FIG. 3C, the frame body bonding jig J is moved to the layered member 10 side along with the second direction D₂, while fixing the nest γ by the pair of supporting parts 41. Thereby, the seal member β and the frame body 20 are bonded. The seal member β and the frame body 20 may be bonded by, for example, heat sealing. After that, as shown in FIG. 3D, the fixation of the nest γ by the pair of supporting parts 41 is released, and the pair of supporting parts are separated from the nest γ. After that, although not illustrated in particular, the gripping jig is peeled off from the frame body bonding jig bonded to the seal member.

According to the present disclosure, by using the frame body bonding jig and the position correcting jig, interference of a nest and a frame body during arranging the frame body in a side surface of a layered member can be inhibited. As described above, when the method for arranging the frame body in the side surface of the layered member is adopted, if the extending direction of the nest that extends to outside the layered member is not uniform (when the height position of the outside edge part of the nest is not uniform), the nest and the frame body (and the gripping jig) easily interfere on the occasion of arranging the frame body in the side surface of the layered member. To this, in the present disclosure, non-uniform height position of the outside edge part of the nest is corrected by using the position correcting jig. Further, since the seal member and the frame body are bonded using the frame body bonding jig in the state the height position of the outside edge part of the nest is fixed, the frame body can be arranged in the side surface of the layered member with high accuracy while inhibiting the interference of the nest and the frame body (and the gripping jig).

Further, the frame body bonding jig includes a gripping jig that grips the frame body. Thereby, occurrence of deformation in the frame body due to thermal strain can be inhibited when the seal member and the frame body are bonded by heat sealing for example. Also, in the present disclosure, a resin part with a frame shape is not formed by resin molding such as injection molding, but a frame body with a frame shape is prepared as an additional member, and that frame body is arranged in the side surface of the layered member. The advantage thereof is such that the improvement of productivity can be achieved since there is no need to use the mold like conventional resin molding.

1. Preparing Step

The preparing step in the present disclosure is a step of preparing a layered member (layered member preparing step). Also, the layered member includes an electrode layered body including a plurality of electrode layered in a first direction, a seal member surrounding the electrode layered body when viewed from the first direction, and a nest that extends from a side surface of the seal member to outside the seal member.

(1) Electrode Layered Body

The electrode layered body in the present disclosure includes a plurality of electrode layered in a first direction. The electrode includes a current collector, and an electrode layer (cathode layer or anode layer) arranged on at least one surface of the current collector.

The electrode layered body is provided with a power generating unit. The power generating unit includes a cathode layer, an anode layer, and a separator arranged between the cathode layer and the anode layer. Power generating unit U₁ shown in FIG. TA includes cathode layer 2, anode layer 3, and separator 4 arranged between the cathode layer 2 and the anode layer 3. Currents of the cathode layer 2 and the anode layer 3 in the power generating unit U₁ are respectively collected by adjacent current collector 1. Also, to the cathode layer 2, the anode layer 3, and the separator 4, a liquid electrolyte is supplied in a step after the bonding step. As a result, the cathode layer 2, the anode layer 3, and the separator 4 are respectively impregnated with the liquid electrolyte.

The electrode layered body may include a plurality of the power generating unit layered in the first direction (thickness direction). The electrode layered body α in FIG. 1A includes a plurality of power generating units (U₁, U₂, U₃) layered in the first direction. As shown in FIG. 1A, the plurality of power generating units may be connected to each other in series. Also, although not illustrated in particular, the plurality of power generating units may be connected to each other in parallel.

The plurality of power generating units are each independent so that the liquid electrolyte does not circulate to each other. In FIG. 1A, the plurality of power generating units U₁ to U₃ are each independent so that the liquid electrolyte does not circulate to each other. For example, the power generating unit U₁ and the power generating unit U₂ are divided by the current collector 1 and the seal member β, and thus are each independent.

One power generating unit may be configured by using two bipolar electrodes. In FIG. 1A, the electrode layered body α is provided with bipolar electrode BP₁ and bipolar electrode BP₂ in the first direction D₁. The separator 4 is arranged between neighboring bipolar electrode BP₁ and bipolar electrode BP₂. The power generating unit U₂ is configured by cathode layer 2b in the bipolar electrode BP₂, anode layer 3a in the bipolar electrode BP₁, and separator 4 arranged between the cathode layer 2b and the anode layer 3a. In this manner, the electrode layered body in the present disclosure may be provided with a plurality of bipolar electrodes in the first direction, and in the plurality of bipolar electrodes, a separator may be respectively arranged between neighboring bipolar electrodes.

(2) Seal Member

The seal member in the present disclosure is arranged to surround the electrode layered body when viewed from the first direction. For example, in FIG. 1A, the seal member β is arranged along with the outer periphery of the current collector 1. When the layered member 10 is viewed from the thickness direction, the seal member β is a member to inhibit the leak of the liquid electrolyte, and usually arranged in an entire outer periphery of the current collector 1. The seal member is, for example, a resin member. Examples of the resin used in the resin member may include a thermoplastic resin such as polypropylene, polyethylene, and polyethylene terephthalate.

(3) Nest

The nest in the present disclosure is arranged to extend from the side surface of the seal member to outside the seal member. The side surface of the seal member refers to a surface that extends to the first direction. The nest is a member configured to form a penetration hole that penetrates inside and outside of the layered member. As shown in FIG. 1A, of the nest γ, inside edge part t1 is positioned inside the layered member 10, and outside edge part t2 protrudes to outside the side surface SS of the layered member 10 (seal member β). The nest γ is supported by the seal member β, which is put up and down in between in the first direction D₁.

Examples of the material for the nest may include a metal. The thickness of the nest is not particularly limited, and for example, it is 0.1 mm or more and 0.4 mm or less. Also, the shape of the nest in a plan view (shape viewed from the thickness direction) is, for example, square.

(4) Layered Member

The layered member in the present disclosure includes the above described electrode layered body, seal member and nest. The layered member may include a block member. As shown in FIG. 3A, when viewed from the first direction D₁, block members δ (δ₁, δ₂) are respectively arranged in positions overlapping the seal member β and the nest γ. Also, as shown in FIG. 3A, the block members δ (δ₁, δ₂) may be respectively arranged in both surfaces of the layered member 10. Also, as shown in FIG. 3C, the block members δ are bonded with the frame body 20 in the bonding step. By arranging the block members δ, airtightness in the edge part of the layered member 10 in the first direction D₁ improves.

For example, when pressure is reduced to perform liquid electrolyte injection, airtightness in the edge part of the layered member in the first direction tends to fall. To this, by arranging the block member, the airtightness in the edge part of the layered member in the first direction improves. The block member is, for example, a resin member. Examples of the resin used in the resin member may include a thermoplastic resin such as polypropylene, polyethylene, and polyethylene terephthalate. Also, the block member and the seal member are preferably bonded, and more preferably welded.

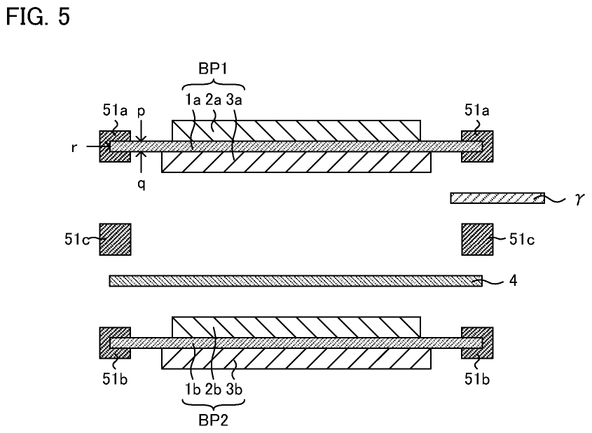

FIG. 5 is a schematic cross-sectional view (deal drawing) exemplifying the method for forming the layered member in the present disclosure. As shown in FIG. 5, bipolar electrode BP₁ and bipolar electrode BP₂ are prepared. The bipolar electrode BP₁ includes cathode layer 2a arranged in one surface of current collector 1a, and anode layer 3a arranged in the other surface of the current collector 1a.

Further, the bipolar electrode BP₁ includes frame member 51a arranged along with the outer periphery of the current collector 1a. When the bipolar electrode BP₁ is viewed from the thickness direction, the frame member 51a is usually arranged along with the entire outer periphery of the current collector 1a. For example, when the shape of the outer periphery of the current collector 1a is square, the frame member 51a is arranged along with the entire outer periphery of that square. Also, as shown in FIG. 5, the frame member 51a preferably covers a part of one main surface p of the current collector 1a, a part of the other main surface q of the current collector 1a, and the whole of side surface r configuring the outer periphery of the current collector 1a.

As shown in FIG. 5, the bipolar electrode BP₂ includes cathode layer 2b arranged in one surface of current collector 1b, and anode layer 3b arranged in the other surface of the current collector 1b. Further, the bipolar electrode BP₂ includes frame member 51b arranged along with the outer periphery of the current collector 1b. The details of the bipolar electrode BP₂ are the same as the details of the bipolar electrode BP₁ described above.

As shown in FIG. 5, the anode layer 3a in the bipolar electrode BP₁ and the cathode layer 2b in the bipolar electrode BP₂ are faced to each other interposing separator 4. Also, as shown in FIG. 5, nest γ and frame member (spacer) 51c are arranged between the frame member 51a in the bipolar electrode BP₁ and the frame member 51b in the bipolar electrode BP₂.

As shown in FIG. 5, the bipolar electrode BP₁, the bipolar electrode BP₂, the separator 4, and the nest γ are arranged, and then the frame members 51a, 51b, and 51c are welded. Thereby, a power generating unit including the cathode layer 2b, the anode layer 3a, and the separator 4 is formed. Also, by welding the frame members 51a, 51b, and 51c, the seal member β exemplified in FIG. 1A is formed. Also, after welding the frame members 51a, 51b, and 51c, for example, a resin layer may be formed by injection molding. In that case, the seal member β includes a layer in which a plurality of frame members 51a, 51b, and 51c are welded, and a resin layer arranged outside the layer. Meanwhile, the seal member in the layered member may be in the condition the plurality of frame members are not welded. In the later described bonding step, the frame body may be welded to the seal member while welding the plurality of frame members.

2. Frame Body Arranging Step

The frame body arranging step in the present disclosure is a step of arranging the frame body in the side surface of the layered member. As shown in FIG. 1C, in the frame body arranging step, the seal member β and the frame body 20 are bonded in a state the nest γ is inserted in the first penetration region P₁ in the frame body 20. As shown in FIG. 1C, the outside edge part t2 of the nest γ preferably protrudes the frame body 20 in second direction D₂ that is an extending direction of the nest γ. In FIG. 1C, one frame body 20 is arranged in the side surface of the seal member β, but a plurality of the frame body 20 may be arranged along with third direction D₃ (third direction D₃ is a direction orthogonal to the first direction D₁ and the second direction D₂). Also, the frame body arranging step includes a jig preparing step, a facing arranging step, a position adjusting step, and a bonding step.

(1) Jig Preparing Step

The jig preparing step in the present disclosure is a step of preparing a frame body bonding jig and a position correcting jig.

(i) Frame Body Bonding Jig

The frame body bonding jig in the present disclosure includes a frame body, and a gripping jig that grips the frame body.

As shown in FIGS. 2A to 2C, the frame body 20 includes first penetration region P₁ that penetrates in the depth direction x. The first penetration region P₁ is a region where the position correcting jig is inserted in the later described position adjusting step. Also, the first penetration region P₁ is a region where the nest is inserted in the later described bonding step. A surface of the frame body 20 that is opposite to the gripping jig 30 side (left side surface in FIGS. 2B and 2C) is bonded with a surface of the seal member.

As shown in FIGS. 2A to 2C, the frame body 20 may include a plurality of first penetration region P₁ along with height direction z. The plurality of penetration region P₁ is arranged each independently, and arranged to correspond to each power generating unit. As shown in FIG. 2A, H₁ designates the height (length in the height direction z) of the first penetration region P₁, and W₁ designates the width (length in width direction y) of the first penetration region P₁. The height H₁ corresponds to the shape of the nest (not illustrated), and is usually smaller than the width W₁. Also, as shown in FIGS. 3B and 3C, a pair of supporting parts 41 (41a, 41b) in the position correcting jig 40 pass the first penetration region P₁ in a state the nest γ is put in between in the bonding step. For this reason, the size of the first penetration region P₁ is set in consideration of this point.

The frame body is, for example, a resin member. Examples of the resin may include a thermoplastic resin such as polypropylene, polyethylene, and polyethylene terephthalate. The shape of the outer periphery of the frame body (shape of the outer periphery viewed from the depth direction x) is not particularly limited, and examples thereof may include a square shape such as rectangular.

As shown in FIGS. 2A to 2C, the gripping jig 30 grips the frame body 20. Also, the gripping jig 30 includes a second penetration region P₂ that penetrates in the depth direction x. The second penetration region P₂ is a region where the position correcting jig is inserted in the later described position adjusting step. Also, the first penetration region P₁ and the second penetration region P₂ are communicated in the depth direction x.

As shown in FIGS. 2A to 2C, the gripping jig 30 may include a plurality of the second penetration region P₂ along with the height direction z. The plurality of the second penetration region P₂ is arranged each independently, and is arranged to correspond to each first penetration region P₁. Also, as shown in FIGS. 3B and 3C, a pair of supporting parts 41 (41a, 41b) in the position correcting jig 40 pass the second penetration region P₂ in a state the nest γ is put in between in the bonding step. For this reason, the size of the second penetration region P₂ is set in consideration of this point.

As shown in FIGS. 2B and 2C, the gripping jig 30 may include groove part 31 configured to fit a part of the frame body 20 thereinto. A part of the frame body 20 is inserted in the groove part 31 of the gripping jig 30 in the depth direction x, and the frame body 20 is gripped by the gripping jig 30. The groove part 31 in FIGS. 2B and 2C is arranged to cover a part of the first main surface s1 of the frame body 20, a part of the second main surface s2 of the frame body 20, and whole of end surface s3 that connects the first main surface s1 and the second main surface s2, and grips the frame body 20. Also, although not illustrated in particular, the gripping jig may not include the groove part configured to fit the frame body thereinto. In this case, for example, the end surface in the frame body and the end surface of the gripping jig are preferably bonded or welded.

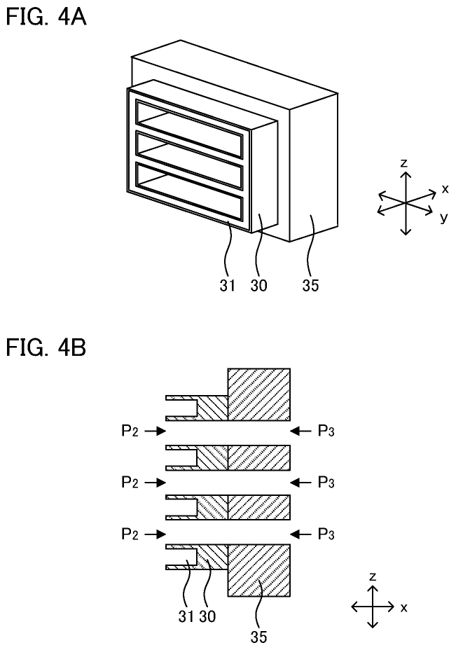

FIG. 4A is a schematic perspective view exemplifying the gripping jig in the present disclosure, and FIG. 4B is a schematic cross-sectional view cutting the gripping jig in FIG. 4A in x-z plane. As shown in FIGS. 4A and 4B, the gripping jig 30 may include connecting member 35 in a surface opposite to the surface where the frame body (not illustrated) is arranged. Using the connecting member 35, the gripping jig 30 and a moving device are connected by, for example, bolting. By moving the moving device along with, for example, the second direction D₂, the frame body bonding jig including the gripping jig 30 also moves along with the second direction D₂. Also, the gripping jig 30 includes the second penetration region P₂, and the connecting member 35 includes a third penetration region P₃. The second penetration region P₂ and the third penetration region P₃ are communicated in the depth direction x. Also, although not illustrated in particular, in the frame body bonding jig, the first penetration region, the second penetration region and the third penetration region are usually communicated in the depth direction x.

The gripping jig is, for example, a metal member such as stainless steel and aluminum. The shape of the outer periphery of the gripping jig (shape of the outer periphery viewed from the depth direction x) is not particularly limited, and examples thereof may include a square shape such as rectangular. Also, as shown in FIG. 2A, when viewed from the depth direction x, the outer periphery of the gripping jig 30 is preferably positioned outside the outer periphery of the frame body 20. The reason therefor is to effectively inhibit the occurrence of deformation of the frame body due to heat strain when the seal member and the frame body are bonded by, for example, heat sealing.

(ii) Position Correcting Jig

The position correcting jig in the present disclosure includes a pair of supporting parts, and a rodlike part connected to the pair of supporting parts. As shown in FIG. 2D, position correcting jig 40 includes a pair of supporting parts 41 (41a, 41b), and rodlike part 42 connected to the pair of supporting parts 41. The pair of supporting parts 41 (41a, 41b) are used to fix the nest by putting the nest in between from the height direction z (up and down direction) in the later described position adjusting step. The rodlike part 42 extends to one direction, and in the later described position adjusting step, it is moved along with the depth direction x in FIGS. 2A to 2C (the second direction D₂ in FIGS. 3A to 3D) with respect to the frame body bonding jig. Also, as shown in FIG. 3A, the position correcting jig 40 may be installed to guide member 50 that guides the movement in the second direction D₂.

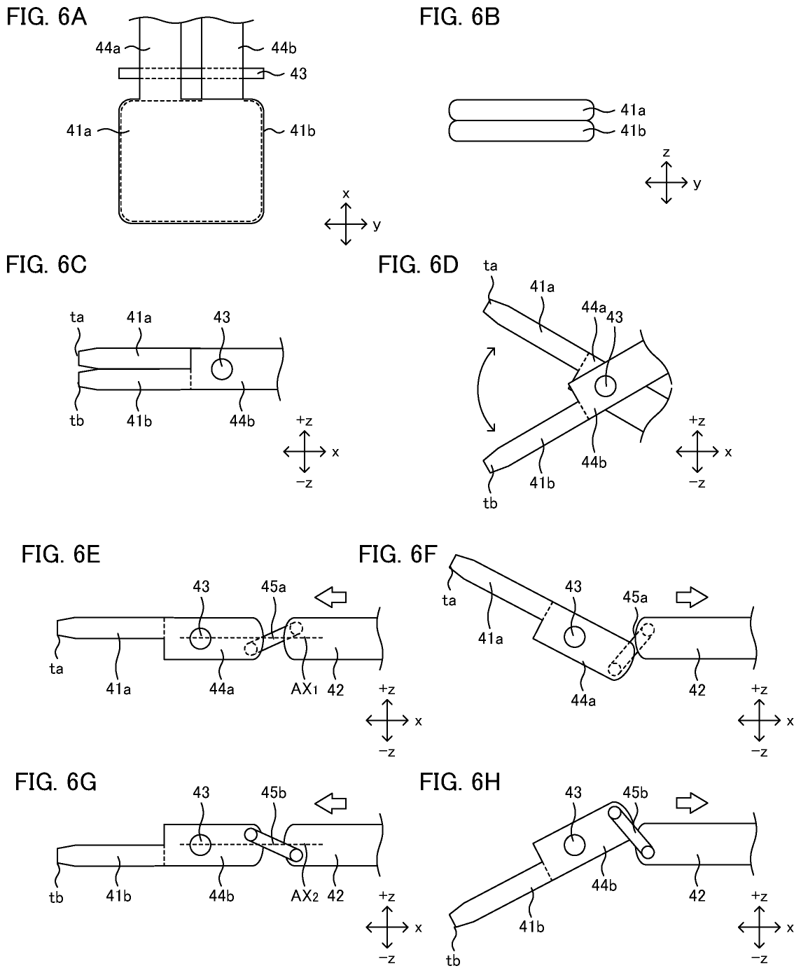

The position correcting jig in the present disclosure is not particularly limited, if it is a jig that can be inserted to the frame body bonding jig, and can put the nest in between and fix the nest. Specific examples of the position correcting jig will be explained with reference to FIGS. 6A to 6H. Here, FIG. 6A is a schematic plan view exemplifying a pair of supporting parts in the position correcting jig and the surrounding area, and FIG. 6B is a schematic side view of the pair of supporting parts in FIG. 6A when viewed from the depth direction x. Also, FIGS. 6C and 6D are schematic side views of the pair of supporting parts in FIG. 6A when viewed from the width direction y, and FIGS. 6E to 6H are schematic side views of each supporting part in FIG. 6A when viewed from the width direction y.

As shown in FIGS. 6A to 6D, the pair of supporting parts 41a and 41b are members configured to fix the nest by putting the nest in between from the height direction z (up and down direction). As shown in FIGS. 6A and 6B, the pair of supporting parts 41a and 41b include a flat surface to fix the nest by putting the nest in between. Also, the supporting parts 41a and 41b respectively include connecting parts 44a and 44b that connect with the rodlike part (not illustrated). Shaft 43 configured to rotate and move the supporting parts 41a and 41b is arranged between the supporting part 41a and the connecting part 44a, as well as between the supporting part 41b and the connecting part 44b.

As shown in FIGS. 6C and 6D, tips ta and tb in the supporting parts 41a and 41b rotate and move around the shaft 43 in the height direction z (up and down direction). In specific, when the nest is put between the position correcting jig, the tip ta in the supporting part 41a rotates and moves to +z side, and the tip tb in the supporting part 41b rotates and moves to −z side. Also, when the position correcting jig fixes the nest, the tip ta moved to +z side rotates and moves to −z side, and the tip tb moved to −z side rotates and moves to +z side.

As shown in FIGS. 6E and 6F, the connecting part 44a is connected to the rodlike part 42 interposing, for example, joint link 45a. As shown in FIG. 6E, an axis that goes though the center of the shaft 43 and is parallel to the depth direction x is regarded as AX₁. On the basis of the axis AX₁, the connecting part 44a and the joint link 45a are connected in −z side, and the joint link 45a and the rodlike part 42 are connected in +z side. By connecting in this manner and, as shown in FIG. 6E, when the rodlike part 42 is moved to the left side of drawing, as shown in FIG. 6F, the tip ta in the supporting part 41a rotates and moves to +z side around the shaft 43. In contrast, when the rodlike part 42 shown in FIG. 6F is moved to the right side of drawing, the tip ta in the supporting part 41a rotates and moves to −z side around the shaft 43.

As shown in FIGS. 6G and 6H, the connecting part 44b is connected to the rodlike part 42 interposing, for example, joint link 45b. As shown in FIG. 6G, an axis that goes through the center of the shaft 43 and is parallel to the depth direction x is regarded as AX₂. On the basis of the axis AX₂, the connecting part 44b and the joint link 45b are connected in +z side, and the joint link 45b and the rodlike part 42 are connected in −z side. By connecting in this manner and, as shown in FIG. 6G, when the rodlike part 42 is moved to the left side of drawing, as shown in FIG. 6H, the tip tb in the supporting part 41b rotates and moves to −z side around the shaft 43. In contrast, when the rodlike part 42 shown in FIG. 6H is moved to the right side of drawing, the tip tb in the supporting part 41b rotates and moves to +z side around the shaft 43.

In this manner, in FIGS. 6E and 6G, when the rodlike part 42 is moved to the left side of drawing, as shown in FIGS. 6F and 6H, the supporting parts 41a and 41b will be opened state. In contrast, in FIGS. 6F and 6H, when the rodlike part 42 is moved to the right side of drawing, as shown in FIGS. 6E and 6G, the supporting parts 41a and 41b will be closed state. Thereby, fixation of the nest by the supporting parts 41a and 41b, and releasing the fixation of the nest by the supporting parts 41a and 41b can be done.

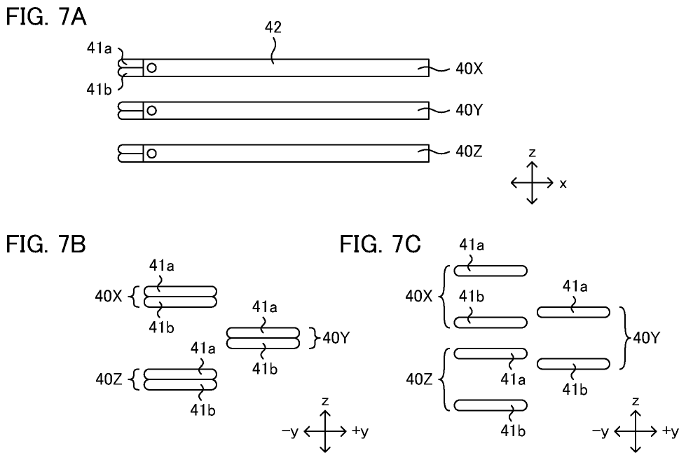

As shown in FIG. 7A, in the side surface view of x-z plane of the depth direction x and the height direction z, a plurality of the position correcting jig 40 (40X, 40Y, 40Z) may be arranged along with the height direction z. In this case, as shown in FIG. 7B, in the side surface view of y-z plane of the width direction y and the height direction z, neighboring position correcting jigs 40 may be arranged zigzag. In FIG. 7B, the position correcting jig 40Y is arranged in +y side on the basis of the position correcting jig 40X, and the position correcting jig 40Z is arranged in −y side on the basis of the position correcting jig 40Y. By adopting such zigzag arrangement, as shown in FIG. 7C, when the pair of supporting parts 41a and 41b in the position correcting jigs 40X, 40Y and 40Z are opened state, interference of neighboring position correcting jigs 40 can be inhibited.

(2) Facing Arranging Step

The facing arranging step in the present disclosure is a step of arranging an outside edge part of the nest in the layered member and the frame body in the frame body bonding jig to face to each other interposing a space.

As shown in FIG. 3A, outside edge part t2 of the nest γ in the layered member 10 and the frame body 20 in the frame body bonding jig J are arranged to face to each other interposing a space. Also, in the later described bonding step, when the seal member and the frame body are bonded by heat sealing, it is preferable to heat at least one of the seal member and the frame body right before the facing arranging step.

(3) Position Adjusting Step

The position adjusting step in the present disclosure is a step of adjusting height position of the nest by inserting the support parts and the rodlike part in the position correcting jig from the second penetration region side toward the first penetration region side in the frame body bonding jig, and putting the nest between the pair of support parts from the first direction so as to be fixed.

As shown in FIG. 3B, the supporting part 41 and the rodlike part 42 in the position correcting jig 40 are inserted from the second penetration region P₂ side to the first penetration region P₁ side in the frame body bonding jig J. In FIG. 3B, the supporting part 41 protrudes from the edge part (edge part in the left side of drawing) of the frame body bonding jig J in the frame body 20 side. After that, the nest γ is put between the pair of supporting parts 41 (41a, 41b) from the first direction D₁. Thereby, even if the height position of the outside edge part of the nest γ is not uniform, the non-uniformity will be corrected. The outside edge part of the nest γ corresponds to the outside edge part t2 exemplified in FIG. 3A.

(4) Bonding Step

The bonding step in the present disclosure is a step of bonding the seal member and the frame body by moving the frame body bonding jig to the layered member side while fixing the nest by the pair of support parts. As shown in FIG. 3C, the frame body bonding jig J is moved to the layered member 10 side along with the extending direction of the rodlike part 42 while fixing the nest γ by the pair of supporting parts 41. After that, the surface of the seal member β in the frame body 20 side and the surface of the frame body 20 in the seal member β side are made contact to bond the seal member β and the frame body 20.

There are no particular limitations on the method for bonding the seal member and the frame body. For example, when the seal member and the frame body are resin members, the both may be welded by heating at least one of the seal member and the frame body. Examples of the method for heating may include a method of irradiating an infrared ray lamp, a method of blowing hot air, and method of pushing against a hot plate. Also, as a bonding method of the seal member and the frame body, an adhesive layer may be arranged between the both. Also, as shown in FIG. 3C, when the layered member 10 includes the block members δ (δ₁, δ₂), in the bonding step, the seal member β and the block members δ are preferably bonded with the frame body 20.

As shown in FIG. 3D, it is preferable to release the fixation of the nest γ by the pair of supporting parts 41 and to separate the pair of the supporting parts 41 from the nest γ after the bonding step. Also, although not illustrated in particular, it is preferable to peel off the gripping jig from the frame body bonding jig bonded to the seal member. Incidentally, in the present disclosure, the gripping jig may not be peeled off from the frame body bonding jig bonded to the seal member.

3. Other Steps

The method for producing the power storage module in the present disclosure may include a penetration hole forming step of forming the penetration hole by removing the nest from the layered member after the above described frame body arranging step. The penetration hole is formed by removing the nest γ from the layered member.

The method for producing the power storage module in the present disclosure may include a liquid electrolyte supplying step of supplying a liquid electrolyte inside the layered member via penetration hole after the above described penetration hole forming step. There are no particular limitations on the method for supplying the liquid electrolyte, and conventionally known method may be used.

The method for producing the power storage module in the present disclosure may include a sealing step of sealing the penetration hole after the above described liquid electrolyte supplying step. There are no particular limitations on the method for sealing the penetration hole, and examples thereof may include a method of sealing the penetration hole by heating and melting the seal member.

4. Power Storage Module

Specific examples of the power storage module in the present disclosure may include a secondary battery (such as a lithium ion secondary battery) and an electric double layered capacitor. Also, examples of the applications of the power storage module may include a power source for vehicles such as hybrid electric vehicles (HEV), plug-in hybrid electric vehicles (PHEV), battery electric vehicles (BEV), gasoline-fueled automobiles and diesel powered automobiles. In particular, it is preferably used as a power source for driving hybrid electric vehicles (HEV), plug-in hybrid electric vehicles (PHEV), and battery electric vehicles (BEV). Also, the power storage module in the present disclosure may be used as a power source for moving bodies other than vehicles (such as rail road transportation, vessel and airplane), and may be used as a power source for electronic products such as information processing equipment.

B. Gripping Jig

The gripping jig in the present disclosure is used for the method for producing the power storage module described above, and includes the second penetration region. The gripping jig is in the same contents as those described in “A. Method for producing power storage module” above; thus, the descriptions herein are omitted. Also, the present disclosure may also provide a frame body bonding jig to be used for the method for producing the power storage module described above, the jig including the frame body and the gripping jig.

C. Position Correcting Jig

The position correcting jig in the present disclosure is used for the method for producing the power storage module described above, and includes the pair of supporting parts and the rodlike part. The position correcting jig is in the same contents as those described in “A. Method for producing power storage module” above; thus, the descriptions herein are omitted.

The present disclosure is not limited to the embodiments. The embodiments are exemplification, and any other variations are intended to be included in the technical scope of the present disclosure if they have substantially the same constitution as the technical idea described in the claims of the present disclosure and have similar operation and effect thereto.

### REFERENCE SINGS LIST

1 current collector
2 cathode layer
3 anode layer
4 separator
10 layered member
20 frame body
30 gripping jig
40 position correcting jig

What is claimed is:

1. A method for producing a power storage module, the method comprising:
a preparing step of preparing a layered member; and
a frame body arranging step of arranging a frame body in a side surface of the layered member, wherein
the layered member includes an electrode layered body including a plurality of electrode layered in a first direction, a seal member surrounding the electrode layered body when viewed from the first direction, and a nest that extends from a side surface of the seal member to outside the seal member;
the frame body arranging step is a step of arranging the frame body in a side surface of the layered member by bonding the seal member and the frame body in a state the nest is inserted in a first penetration region in the frame body;
the frame body arranging step includes:
a jig preparing step of preparing a frame body bonding jig including the frame body, and a gripping jig that grips the frame body and that includes a second penetration region corresponding to the first penetration region, as well as preparing a position correcting jig including a pair of supporting parts and a rodlike part connected to the pair of supporting parts;
a facing arranging step of arranging an outside edge part of the nest in the layered member and the frame body in the frame body bonding jig to face to each other interposing a space;
a position adjusting step of adjusting height position of the outside edge part of the nest by inserting the supporting parts and the rodlike part in the position correcting jig from the second penetration region side toward the first penetration region side in the frame body bonding jig, and putting the nest between the pair of supporting parts from the first direction so as to be fixed; and
a bonding step of bonding the seal member and the frame body by moving the frame body bonding jig to the layered member side while fixing the nest by the pair of supporting parts.

2. The method for producing a power storage module according to claim 1, wherein
the layered member includes a block member arranged in a position overlapping the seal member and the nest when viewed from the first direction; and
in the bonding step, the seal member, the block member, and the frame body are bonded.

3. The method for producing a power storage module according to claim 1, wherein
the electrode layered body is provided with a bipolar electrode including a cathode layer arranged in one surface of a current collector, and an anode layer arranged in the other surface of the current collector;
the electrode layered body is provided with a plurality of the bipolar electrode in the first direction; and
in the plurality of the bipolar electrode, a separator is respectively arranged between neighboring the bipolar electrode.

4. A gripping jig to be used in the method for producing a power storage module according to claim 1, the jig including the second penetration region.

5. A position correcting jig to be used in the method for producing a power storage module according to claim 1, the jig including the pair of supporting parts and the rodlike part.
